(19) United States
(12) Patent Application Publication
(10) Pub. No.: US 2011/0308687 A1
(43) Pub. Date: Dec. 22, 2011

(54) Pneumatic Tire Having a Top Area with a Water Barrier Layer

(75) Inventor: Salvatore PAGANO, Tokyo (JP)

(73) Assignee: Michelin Recherche et Technique S.A., Granges-Paccot (CH)

(21) Appl. No.: 13/131,670

(22) PCT Filed: Nov. 16, 2009
(86) PCT No.: PCT/EP2009/008131

§ 371 Date: Sep. 8, 2011

(30) Foreign Application Priority Data
Nov. 27, 2008 (FR) 0858051

(51) Int. Cl. B60C 9/02

(52) U.S. Cl. 152/548

(57) ABSTRACT

A radial tire (1) for motor vehicle, comprising: a crown (2) surmounted by a tread (3) provided with at least one radially outer part (3a) intended to come into contact with the road; two inextensible beads (4), two sidewalls (5) connecting the beads (4) to the tread (3), a carcass reinforcement (6) passing into the two sidewalls (5) and anchored in the beads (4); the crown (2) being reinforced by a crown reinforcement or belt (7) placed circumferentially between the carcass reinforcement (6) and the tread (3); a radially inner elastomer layer (3b, 8) known as a “underlayer”, having a formulation different from the formulation of the radially outer elastomer layer (3a), this underlayer being placed between the radially outer layer (3a) of the tread (3) and the belt (7), wherein said underlayer comprises 50 to 100 phr of a copolymer based on stirene and on butadiene, preferably an SBR having in particular a Tg above −40° C., a reinforcing filler and between 10 and 150 phr of a platy filler. This elastomer underlayer has excellent water-barrier properties, giving the tire and its belt improved protection against the risks of water penetration through the tread.

The invention relates to tires for motor vehicles and also to rubbery compositions that can be used for the manufacture of such tires.

It relates more particularly to the rubbery compositions used in the crown of tires having a radial carcass reinforcement, and also to the protection of the crown reinforcements also known as belts of these tires.

A tire having a radial carcass reinforcement comprises, in a known manner, a tread, two inextensible beads, two sidewalls joining the beads to the tread and a belt placed circumferentially between the carcass reinforcement and the tread, this belt being composed of various plies (or “layers”) of rubber which may or may not be reinforced with reinforcing elements (“reinforcements”) such as cords or monofilaments, of the metallic or textile type.

More specifically, a tire belt generally consists of at least two superposed belt plies, sometimes referred to as “working” plies or “crossed” plies, the reinforcements of which are placed so as to be practically parallel to one another within a ply, but crossed from one ply to the other, that is to say inclined, whether symmetrically or not, relative to the median circumferential plane, by an angle which is generally between 10° and 45° depending on the type of tire in question. Each of these two crossed plies consist of a rubber matrix or “calendering gum” that coats the reinforcements. In the belt, the crossed plies may be finished off by various other auxiliary rubber plies or layers, having widths that vary depending on the case, and which may or may not contain reinforcements; mention will be made by way of example of simple rubber cushions, of plies known as “protective” plies, the role of which is to protect the rest of the belt from external attack, perforations, or else plies known as “hooping” plies comprising reinforcements oriented substantially along the circumferential direction (plies known as “zero degree” plies), irrespective of whether they are radially outer or inner to the crossed plies.

For the reinforcement of the belts above, in particular of their crossed plies, use is generally made of steel cords composed of thin wires assembled together by cabling or twisting.

To effectively fulfil their role of reinforcing the belts of radial tires, subjected, as is known, to very high stresses when the tires are running, the steel cords must satisfy a very large number of technical, sometimes contradictory, criteria such as a high compression endurance, a high tensile strength, a high wear resistance and a high corrosion resistance, a strong adhesion to the surrounding rubber, and must be capable of maintaining these properties at a very high level for as long a time as possible.

However, it is known that corrosive agents such as water, capable of penetrating into the tires, especially following cuts or other attacks on their crown, may travel to the belt. The presence of moisture in the belt, moreover under relatively high temperature conditions, risks causing corrosion and accelerating fatigue processes (phenomena known as “corrosion fatigue”), while being detrimental to the adhesion between the steel cords and the neighbouring rubber composition, finally playing a major role in the longevity of the tire performances.

However, the Applicants have discovered, during their research, a specific rubber composition that has excellent water-barrier properties and which is thus capable of giving improved protection to the belt of the tires.

Consequently, a first subject of the invention relates to a radial tire for a motor vehicle, comprising:
a crown surmounted by a tread provided with at least one radially outer part intended to come into contact with the road;
two beads, two sidewalls connecting the beads to the tread, a carcass reinforcement passing into the two sidewalls and anchored in the beads;
the crown being reinforced by a crown reinforcement or belt placed circumferentially between the carcass reinforcement and the tread;
a radially inner elastomer layer known as a “underlayer”, having a formulation different from the formulation of the radially outer elastomer layer, this underlayer being placed between the radially outer layer of the tread and the belt,
characterized in that said underlayer comprises at least 50 to 100 phr of a copolymer based on stirene and on butadiene, a reinforcing filler and between 10 and 150 phr of a platy filler.

According to a first preferred embodiment of the invention, this protective elastomer underlayer is internal to the tread, constituting the part commonly known as the “base” of a tread of “cap-base” construction. In this case, the underlayer or base is of course an unpatterned part, that is to say that it is not intended to come into contact with the road when the tire is running, unlike the radially outer part intended to come into contact with the road and that is therefore, by definition, patterned.

According to another preferred embodiment of the invention, the protective elastomer underlayer is external to the tread, placed in the crown between the tread and the belt.

The tires of the invention are particularly indented to be fitted on motor vehicles of the passenger type, including 4×4 (four-wheel drive) vehicles and SUV vehicles (“Sport Utility Vehicles”), two-wheel vehicles (especially motorcycles) as well as industrial vehicles chosen in particular from vans and heavy vehicles (i.e. underground trains, buses, road transport vehicles such as lorries, towing vehicles and trailers, off-road vehicles such as agricultural or civil-engineering vehicles).

The invention relates to the above tires both in the uncured state (i.e. before curing) and in the cured state (i.e. after crosslinking or vulcanization).

The invention also relates to the use as a water-barrier layer, in a rubber article, of an elastomer composition, the formulation of which is as defined above.

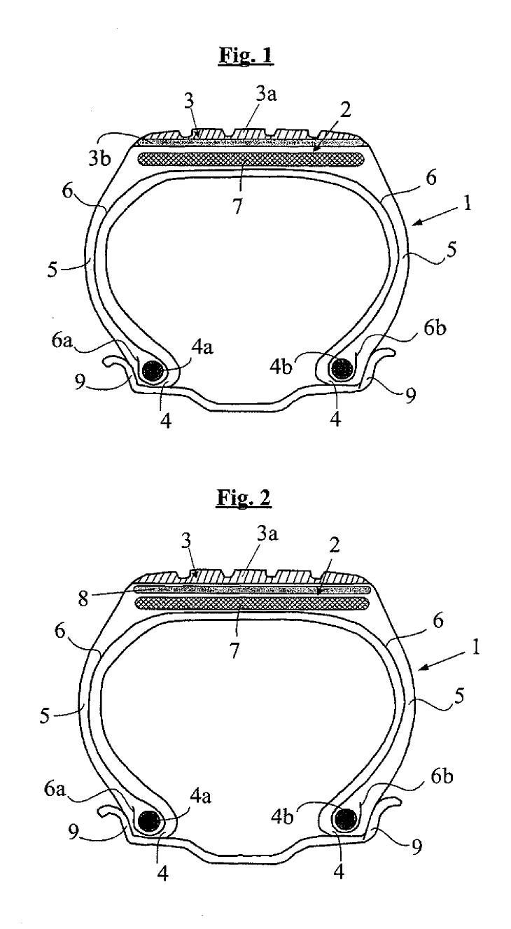

The invention and its advantages will be readily understood in light of the description and exemplary embodiments that follow, and also FIGS. 1 and 2 relating to these examples which schematically show, in radial cross section, two examples of radial tires in accordance with the invention.

### I—DEFINITIONS

In the present application, the following definitions are understood, in a known manner:
“axial”: a direction parallel to the axis of rotation of the tire; this direction may be “axially interior” when it is oriented towards the inside of the tire and “axially exterior” when it is oriented toward the outside of the tire;
“bead”: the inextensible portion of the tire internally radially adjacent to the sidewall and the base of which is intended to be mounted on a rim seat of a vehicle wheel;
“diene elastomer (or rubber)”: an elastomer resulting at least in part (i.e. a homopolymer or a copolymer) from diene monomer(s) (i.e. monomer(s) bearing two carbon-carbon double bonds which may or may not be conjugated);
“isoprene elastomer”: a homopolymer or copolymer of isoprene, in other words a diene elastomer chosen from the group consisting of natural rubber (NR), synthetic polyisoprenes (IRs), various copolymers of isoprene and blends of these elastomers;
“sidewall”: the portion of the tire, usually of low flexural stiffness, located between the crown and the bead;
“secant modulus in extension” (denoted by E10): the tensile modulus measured in a second elongation (i.e. after an accommodation cycle) at 10% elongation (according to ASTM D412 1998; test specimen “C”), this modulus being the “true” secant modulus, i.e. the modulus relative to the actual cross section of the test specimen (standard temperature and relative humidity conditions according to the ASTM D 1349 (1999)) standard;
“phr”: signifies parts by weight per hundred parts of elastomer (of the total of the elastomers if several elastomers are present);
“radial”: a direction that passes through the axis of rotation of the tire and normal to the latter; this direction may be “radially internal (or inner)” or “radially external (or outer)” depending on whether it is oriented towards the axis of rotation of the tire or towards the outside of the tire;
“reinforcement” or “reinforcing element”: both of monofilaments and of multifilaments, or of assemblies such as cords, folded yarns or else any type of equivalent assembly, irrespective of the material and the treatment of these reinforcements, for example surface treatment or coating such as rubber coating, or else presizing to promote adhesion to the rubber;
“circumferentially oriented reinforcement” or “circumferential reinforcement”: a reinforcement oriented substantially parallel to the circumferential direction of the tire, that is to say making, with this direction, an angle that does not deviate by more than five degrees from the circumferential direction;
“radially oriented reinforcement” or “radial reinforcement”: a reinforcement contained substantially within one and the same axial plane or in a plane that makes, with an axial plane, an angle of less than or equal to 10 degrees.

Moreover, in the present description and unless expressly indicated otherwise, all the percentages (%) indicated are % by weight; similarly, any interval of values denoted by the expression “between a and b” represents the range of values of greater than “a” and of less than “b” (i.e. the limits a and b excluded) whereas any interval of values denoted by the expression “from a to b” means the range of values going from “a” to “b” (i.e. including the strict limits a and b).

### II—DETAILED DESCRIPTION OF THE INVENTION

The tire of the invention therefore has the essential feature of being provided with a underlayer or base comprising a rubber composition which comprises at least 50 to 100 phr of a copolymer based on stirene and on butadiene, a reinforcing filler, and between 10 and 150 phr of a platy filler, which components will be described in detail below.

### II-1.—Formulation of the Protective Elastomer Underlayer

### II-1.-A Copolymer Based on Stirene and on Butadiene

The rubber composition forming the protective elastomer underlayer has a first essential feature comprising from 50 to 100 phr of a copolymer based on stirene and on butadiene, that is to say a copolymer of at least one stirene monomer and of at least one butadiene monomer; in other words, said copolymer based on stirene and on butadiene comprises, by definition, at least units derived from stirene and units derived from butadiene.

Preferably, the content of said copolymer, in the protective elastomer layer, is within a range from 50 to 90 phr, more preferably within a range from 60 to 85 phr.

Suitable butadiene monomers are in particular 1,3-butadiene, 2-methyl-1,3-butadiene, 2,3-di(C₁-C₅ alkyl)-1,3-butadienes such as for example 2,3-dimethyl-1,3-butadiene, 2,3-diethyl-1,3-butadiene, 2-methyl-3-ethyl-1,3-butadiene or 2-methyl-3-isopropyl-1,3-butadiene and an aryl-1,3-butadiene. Suitable stirene monomers are in particular stirene, methylstirenes, para-(tert-butyl)stirene, methoxystirenes and chlorostirenes.

Said copolymer based on stirene and on butadiene may have any microstructure, which is a function of the polymerization conditions used, in particular of the presence or absence of a modifying and/or randomizing agent and of the amounts of modifying and/or randomizing agents used. It may be, for example, a block, statistical, sequential or microsequential copolymer, and may be prepared in dispersion or in solution; it may be coupled and/or star-branched or else functionalized with a coupling and/or star-branching or functionalizing agent.

Preferably, the copolymer based on stirene and on butadiene is chosen from the group consisting of stirene-butadiene (abbreviated to SBR) copolymers, stirene-butadiene-isoprene (abbreviated to SBIR) copolymers and blends of such copolymers.

Among the SBIR copolymers, mention may especially be made of those having a stirene content between 5% and 50% by weight and more particularly between 10% and 40%, an isoprene content between 15% and 60% by weight and more particularly between 20% and 50%, a butadiene content between 5% and 50% by weight and more particularly between 20% and 40%, a content (mol %) of 1,2- units of the butadiene part of between 4% and 85%, a content (mol %) of trans-1,4- units of the butadiene part of between 6% and 80%, a content (mol %) of 1,2- units plus 3,4- units of the isoprene part of between 5% and 70% and a content (mol %) of trans-1,4- units of the isoprene part of between 10% and 50%.

More preferably, an SBR copolymer is used. Among the SBR copolymers, mention may especially be made of those having a stirene content of between 5% and 60% by weight and more particularly of between 20% and 50%, a content (mol %) of 1,2- bonds of the butadiene part of between 4% and 75% and a content (mol %) of trans-1,4- bonds of between 10% and 80%.

Preferably, the glass transition temperature (or “T_{g}”) of said copolymer based on stirene and on butadiene is above −40° C., in particular between −40° C. and 0° C.; more preferably still it is above −35° C., in particular between −35° C. and 0° C. According to one particularly preferred embodiment, the T_{g} of said copolymer is between −30° C. and 0° C. (for example, within a range from −25° C. to −5° C.).

The T_{g} of the elastomers described here is measured in a conventional manner, well known to a person skilled in the art, on an elastomer in the dry state (i.e. without extender oil) and by DSC (for example according to ASTM D3418-1999).

A person skilled in the art knows how to modify the microstructure of a copolymer based on stirene and on butadiene, in particular of an SBR, in order to increase and adjust its T_{g}, especially by playing with the contents of stirene, of 1,2- bonds or else of trans-1,4- bonds of the butadiene part. Use is more preferably made of an SBR (solution or emulsion) having a stirene content (mol %) which is greater than 35%, more particularly between 35% and 60%, in particular within a range from 38% to 50%. SBRs having a relatively high T_{g} are well known to a person skilled in the art; they have been used in particular in tire treads for improving some of their standard properties.

With the above copolymer based on stirene and on butadiene, at least one second diene elastomer, different from said copolymer (i.e. not comprising units derived from stirene and butadiene) may be combined, said second diene elastomer being present in a weight content which is consequently at most equal to 50 phr (as a reminder, phr stands for parts by weight per hundred parts of elastomer, that is to say of the total of the elastomers present in the protective elastomer layer).

This optional second diene elastomer is preferably chosen from the group consisting of natural rubbers (NR), synthetic polyisoprenes (IR), polybutadienes (BR), isoprene copolymers and blends of these elastomers. Such copolymers are more preferably chosen from the group consisting of isoprene-butadiene copolymers (BIR) and isoprene-stirene copolymers (SIR).

Especially suitable, among the latter, are polybutadiene (BR) homopolymers and in particular those having a content (mol %) of 1,2- units of between 4% and 80% or those having a content (mol %) of cis-1,4- units of greater than 80%; polyisoprene (IR) homopolymers; butadiene-isoprene copolymers (BIR) and especially those having an isoprene content of between 5% and 90% by weight and a T_{g} from −40° C. to −80° C.; and isoprene-stirene copolymers (SIR) and especially those having a stirene content of between 5% and 50% by weight and a T_{g} of between −25° C. and −50° C.

According to one preferred embodiment, the second diene elastomer is an isoprene elastomer, more preferably natural rubber or a synthetic polyisoprene of cis-1,4- type; among these synthetic polyisoprenes, use is preferably made of polyisoprenes having a content (mol %) of cis-1,4- bonds of greater than 90%, more preferably still of greater than 98%.

More preferably, the content of second diene elastomer, in particular of isoprene elastomer, especially of natural rubber, is within a range from 10 to 50 phr, more preferably still within a range from 15 to 40 phr.

Synthetic elastomers other than diene elastomers, or even polymers other than elastomers, for to example thermoplastic polymers, could also be combined, in a minority amount, with the diene elastomers described previously.

### II.1-B. Reinforcing Filler

Use may be made of any type of reinforcing filler known for its ability to reinforce a rubber composition which can be used for the manufacture of tires, for example an organic filler, such as carbon black or else a reinforcing inorganic filler, such as silica with which a coupling agent is, in a known manner, combined.

Such a reinforcing filler preferably consists of nanoparticles, the average (weight-average) size of which is less than 500 rim, usually between 20 and 200 nm, in particular and preferably between 20 and 150 rim.

Preferably, the content of total reinforcing filler (in particular silica or carbon black or a mixture of silica and carbon black) is greater than 20 phr, especially between 20 and 100 phr. Below 20 phr, the cohesion and the mechanical properties of the underlayer risk being insufficient for certain applications, whereas above 100 phr there is a risk of increasing the hysteresis and therefore the rolling resistance of the tires. For these reasons, the content of total reinforcing filler is more preferably in a range from 25 to 80 phr, in particular from 30 to 70 phr.

All carbon blacks conventionally used in tires or their treads (“tire-grade” blacks) are suitable as carbon blacks. Mention will more particularly be made, among the latter, of the reinforcing carbon blacks of the 100, 200 or 300 series, or of the blacks of the 600 or 700 series (ASTM grades), such as, for example, the N115, N134, N234, N326, N330, N339, N347, N375, N683 or N772 blacks. The carbon blacks could, for example, already be incorporated in the isoprene elastomer in the form of a masterbatch (see, for example, Applications WO 97/36724 or WO 99/16600).

Mention may be made, as examples of organic fillers other than carbon blacks, of the functionalized polyvinyl organic fillers as described in Applications WO-A-2006/069792, WO-A-2006/069793, WO-A-2008/003434 and WO-A-2008/003435.

The expression “reinforcing inorganic filler” should be understood here to mean any inorganic or mineral filler, whatever its colour and its (natural or synthetic) origin, also known as “white filler”, “clear filler” or even “non-black filler”, in contrast to carbon black, capable of reinforcing by itself alone, without means other than an intermediate coupling agent, a rubber composition intended for the manufacture of tires, in other words capable of replacing, in its reinforcing role, a conventional tire-grade carbon black; such a filler is generally characterized, in a known manner, by the presence of hydroxyl (—OH) groups at its surface.

Mineral fillers of the siliceous type, in particular silica (SiO₂), are suitable in particular as reinforcing inorganic fillers. The silica used may be any reinforcing silica known to a person skilled in the art, in particular any precipitated or pyrogenic silica having a BET surface area and a CTAB specific surface area that are both less than 450 m²/g, preferably from 30 to 400 m²/g, in particular between 60 and 300 m²/g. Mention will be made, as highly dispersible precipitated silicas (“HDSs”), for example, of the Ultrasil 7000 and Ultrasil 7005 silicas from Degussa, the Zeosil 1165 MP, 1135 MP and 1115 MP silicas from Rhodia, the Hi-Sil EZ150G silica from PPG and the Zeopol 8715, 8745 and 8755 silicas from Huber.

In order to couple the reinforcing inorganic filler to the diene elastomer, use is made, in a known manner, of an at least bifunctional coupling agent (or bonding agent) intended to provide a satisfactory connection, of chemical and/or physical nature, between the inorganic filler (surface of its particles) and the diene elastomer. Use is made in particular of at least bifunctional organosilanes or polyorganosiloxanes.

Use is especially made of polysulphide-containing silanes, referred to as “symmetrical” or “asymmetrical” depending on their particular structure, as described, for example, in Applications WO 03/002648 (or US 2005/016651) and WO 03/002649 (or US 2005/016650).

Particularly suitable, without the definition below being limiting, are polysulphide-containing silanes corresponding to the following general formula (I):

Z—A—Sₓ—A—Z, in which: (I)
x is an integer from 2 to 8 (preferably from 2 to 5);
the A symbols, which are identical or different, represent a divalent hydrocarbon radical (preferably, C₁-C₁₈ alkylene groups or C₆-C₁₂ arylene groups, more particularly C₁-C₁₀, especially C₁-C₄, alkylenes, in particular propylene);
the Z symbols, which are identical or different, correspond to one of the formulae below:

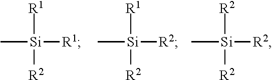

in which:
the R¹ radicals, which are substituted or unsubstituted and identical to or different from one another, represent a C₁-C₁₈ alkyl, C₅-C₁₈ cycloalkyl or C₆-C₁₈ aryl group (preferably, C₁-C₆ alkyl, cyclohexyl or phenyl groups, especially C₁-C₄ alkyl groups, more particularly methyl and/or ethyl);
the R² radicals, which are substituted or unsubstituted and identical to or different from one another, represent a C₁-C₁₈ alkoxyl or C₅-C₁₈ cycloalkoxyl group (preferably a group chosen from C₁-C₈ alkoxyls and C₅-C₈ cycloalkoxyls, more preferably still a group chosen from C₁-C₄ alkoxyls, in particular methoxyl and ethoxyl).

Mention will more particularly be made, as examples of polysulphide-containing silanes, of bis(3-trimethoxysilylpropyl) polysulphides or bis(3-triethoxysilylpropyl) polysulphides. Use is in particular made, among these compounds, of bis(3-triethoxysilylpropyl) tetrasulphide, abbreviated to TESPT, or bis(triethoxysilylpropyl) disulphide, abbreviated to TESPD. Mention will also be made, as preferred examples, of bis(mono(C₁-C₄)alkoxyldi-(C₁-C₄)alkylsilylpropyl) polysulphides (in particular disulphides, trisulphides or tetrasulphides), more particularly bis(monoethoxydimethylsilylpropyl) tetrasulphide, as described in Patent Application WO 02/083782 (or U.S. Pat. No. 7,217,751).

Mention will especially be made, as an example of a coupling agent other than a polysulphide-containing alkoxysilane, of bifunctional POSs (polyorganosiloxanes) or else of hydroxysilane polysulphides (R²═OH in formula (I) above), such as described, for example, in Patent Applications WO 02/30939 (or U.S. Pat. No. 6,774,255) and WO 02/31041 (or US 2004/051210), or else of silanes or POSs bearing azodicarbonyl functional groups, such as described, for example, in Patent Applications WO 2006/125532, WO 2006/125533 or WO 2006/125534.

In the protective underlayer, when it is reinforced by an inorganic filler such as silica, the content of coupling agent is preferably between 2 and 12 phr, more preferably between 3 and 8 phr.

A person skilled in the art will understand that, as equivalent filler to the reinforcing inorganic filler described in the present section, a reinforcing filler of another nature, in particular organic nature, could be used provided that this reinforcing filler is covered with an inorganic layer, such as silica, or else comprises functional sites, in particular hydroxyl sites, at its surface that require the use of a coupling agent in order to form the bond between the filler and the elastomer.

### II.1-C. Platy Filler

The underlayer of the tire according to the invention has another essential feature of comprising between 10 and 150 phr of a platy filler.

Below the indicated minimum, the targeted technical effect is insufficient, whereas above the recommended maximum, crippling problems of increase in the modulus, of embrittlement of the composition and also filler dispersion and processability difficulties are encountered, not to mention a significant degradation of the hysteresis. For all these reasons indicated above, the content of platy filler is preferably between 20 and 100 phr, more preferably still in a range from 25 to 80 phr.

Moreover, for an optimum performance, expressed this time by volume and no longer by weight, the content of platy filler is preferably less than 30%, more preferably less than 25%, in particular less than 20% (% by volume of elastomer composition or protective elastomer underlayer).

Fillers referred to as platy fillers are well known to a person skilled in the art. They have especially been used in pneumatic tires for reducing the permeability of conventional gastight layers (“inner liners”) based on butyl rubber. In these layers based on butyl rubber, they are generally used at relatively low levels, which do not usually exceed 10 to 25 phr (see, for example, patent documents US 2004/0194863, WO 2006/047509).

They are generally in the form of stacked plates, platelets, sheets or foils with a relatively pronounced anisometry of these particles. Their aspect ratio (F=L/E) is generally greater than 2, more often greater than 3 or than 5. L represents the median length (or larger dimension) and E the median thickness of these platy fillers, these averages being calculated by number. Preferably, this aspect ratio is between 2 and 200, especially between 3 and 150, more preferably still in a range from 5 to 100, in particular from 5 to 50.

These platy fillers are preferably of micrometer size, that is to say that they are in the form of microparticles, the median size or length (L) of which is greater than 1 μm, typically between a few μm (for example 5 or 10 μm) and a few hundred μm (for example 500 or even 800 μm). According to one preferred embodiment, the median length (L) of the particles is between 5 and 500 μm, more preferably between 50 and 250 μm. According to another preferred embodiment, the median thickness (E) of the particles is itself between 0.5 and 50 μm, especially between 2 and 30 μm.

Preferably, the platy fillers used in accordance with the invention are chosen from the group composed of graphites, phyllosilicates and mixtures of such fillers. Among the phyllosilicates, mention will especially be made of clays, talcs, micas, kaolins, these phyllosilicates possibly being modified or not for example by a surface treatment; as examples of such modified phyllosilicates, mention may especially be made of micas covered with titanium oxide, and clays modified by surfactants (“organoclays”).

Use is preferably made of platy fillers having a low surface energy, that is to say that are relatively apolar, such as those chosen from the group consisting of graphites, talcs, micas and mixtures of such fillers, the latter possibly being modified or not, more preferably still from the group consisting of graphites, talcs and mixtures of such fillers. Among the graphites use may be made of natural graphites and synthetic graphites.

As examples of micas, mention may be made of the micas sold by CMMP (Mica-MU®, Mica-Soft®, Briomica® for example), vermiculites (especially the Shawatec® vermiculite sold by CMMP or the Microlite® vermiculite sold by W.R. Grace), modified or treated micas (for example, the Iriodin® range sold by Merck). As examples of graphites, mention may be made of the graphites sold by Timcal (Timrex® range). As examples of talcs, mention may be made of the talcs sold by Luzenac.

The introduction of platy fillers into the elastomer composition may be carried out according to various known processes, for example by compounding in solution, by bulk compounding in an internal mixer, or else by compounding via extrusion.

For the particle size analysis and the calculation of the median size of the (micro)particles of platy filler, various known methods can be applied, for example via laser scattering (see, for example, ISO-8130-13 standard or JIS K5600-9-3 standard).

It is also possible to use, simply and preferably, a particle size analysis via mechanical seaving; the operation consists in seaving a defined amount of sample (for example, 200 g) on a vibrating table for 30 min with different mesh diameters (for example, according to an increasing ratio, with meshes (in μm) of 75, 105, 150, 180, etc.); the oversize material collected on each sieve is weighed on a precision balance; the % of oversize material for each mesh diameter relative to the total weight of product is deduced therefrom; the median size (or median diameter) is finally calculated in a known manner from the histogram of the particle size distribution.

### II.-1-D. Various Additives

The elastomer composition of the protective elastomer underlayer may also comprise all or some of the usual additives customarily used in the rubber compositions for tires, especially those intended for the manufacture of a tread base of cap-base construction, such as, for example, protective agents such as chemical antiozonants, antioxidants, plasticizing agents or extender oils, whether the latter are of aromatic or non-aromatic nature, in particular non-aromatic or very weakly aromatic oils, for example of naphthenic or paraffinic type, having a high viscosity or preferably having a low viscosity, MES oils, TDAE oils, hydrocarbon plasticizing resins with a high T_{g}, tackifying resins, reinforcing resins, methylene acceptors or methylene donors, a crosslinking system based either on sulphur or on sulphur donors and/or on peroxide and/or on bismaleimides, vulcanization accelerators and vulcanization activators.

In particular, it turned out that hydrocarbon plasticizing resins with a high T_{g}, preferably above 20° C., more preferably above 30° C. (according to ASTM D3418 (1999)), can advantageously be used since they may make it possible to further improve the technical “water barrier” effect provided by the protective elastomer underlayer described previously.

Hydrocarbon resins (it is recalled that the term “resin” is reserved, by definition, for a compound which is solid at 23° C.) are polymers well known to a person skilled in the art that can be used in particular as plasticizing agents or tackifying agents in polymer matrices. They have been described, for example, in the work entitled “Hydrocarbon Resins” by R. Mildenberg, M. Zander and G. Collin (New York, VCH, 1997, ISBN 3-527-28617-9), chapter 5 of which is devoted to their applications, in particular in the tire rubber field (5.5. “Rubber Tires and Mechanical Goods”). They may be aliphatic, aromatic, hydrogenated aromatic, or of the aliphatic/aromatic type, i.e. based on aliphatic and/or aromatic monomers. They may be natural or synthetic, whether or not based on petroleum (if such is the case, they are also known as petroleum resins). They are preferably exclusively hydrocarbon, i.e. they contain only carbon and hydrogen atoms.

Preferably, their number-average molecular weight (Mₙ) is between 400 and 2000 g/mol, especially between 500 and 1500 g/mol; their polydispersity index (Iₚ) is preferably less than 3, especially less than 2 (NB: Iₚ=M_{w}/Mₙ with M_{w} being the weight-average molecular weight). The macrostructure (M_{w}, Mₙ and Iₚ) of the hydrocarbon resin is determined by size exclusion chromatography (“SEC”): tetrahydrofuran solvent; 35° C. temperature; 1 g/l concentration; 1 ml/min flow rate; solution filtered on a filter of 0.45 μm porosity before injection; Moore calibration using polystirene standards; set of 3 “WATERS” columns in series (“STYRAGEL” HR4E, HR1 and HR0.5); differential refractometer (“WATERS 2410”) detection and its associated operating software (“WATERS EMPOWER”).

As examples of the above hydrocarbon plasticizing resins, mention will especially be made of cyclopentadiene or dicyclopentadiene homopolymer or copolymer resins, terpene (e.g. alpha-pinene, beta-pinene, dipentene or polylimonene) homopolymer or copolymer resins, C₅-cut homopolymer or copolymer resins or C₉-cut homopolymer or copolymer resins, for example C₅-cut/stirene copolymer resins or C₅-cut/C₉-cut copolymer resins.

The content of hydrocarbon resin is preferably between 5 and 60 phr, especially between 5 and 50 phr, more preferably still in a range from 10 to 40 phr.

The compositions of the protective elastomer underlayer may also contain coupling activators when a coupling agent is used, agents for covering the inorganic filler when an inorganic filler is used, or more generally processing aids capable, in a known manner, owing to an improvement in the dispersion of the filler in the rubber matrix and to a lowering in the viscosity of the compositions, of improving their ability to be processed in the uncured state; these agents are, for example, hydrolysable silanes or hydroxysilanes such as alkylalkoxysilanes, polyols, polyethers, amines or hydroxylated or hydrolysable polyorganosiloxanes.

### II.2—Manufacture of the Compositions

The rubber compositions forming the protective elastomer underlayer are manufactured in appropriate mixers using, for example, two successive preparation phases according to a procedure well known to a person skilled in the art: a first phase of thermomechanical working or kneading (sometimes referred to as a “non-productive” phase) at high temperature, up to a maximum temperature of between 130° C. and 200° C., preferably between 145° C. and 185° C., followed by a second phase of mechanical working (sometimes referred to as a “productive” phase) at a lower temperature, typically below 120° C., for example between 60° C. and 100° C., finishing phase during which the crosslinking or vulcanization system is incorporated.

A process that can be used for the manufacture of such rubber compositions comprises, for example, and preferably, the following stages:
in a mixer, incorporating into 50 to 100 phr of the copolymer based on stirene and on butadiene, the reinforcing filler and between 10 and 150 phr of the platy filler, everything being kneaded thermomechanically, in one or more steps, until a maximum temperature of between 130° C. and 200° C. is reached;
cooling the combined mixture to a temperature below 100° C.;
subsequently incorporating a crosslinking system;
kneading everything up to a maximum temperature below 120° C.;
extruding or calendering the rubber composition thus obtained.

By way of example, the first (non-productive) phase is carried out in a single thermomechanical stage during which all the necessary constituents, the optional additional filler-covering agents or processing aids, and other various additives, with the exception of the crosslinking system, are introduced into an appropriate mixer, such as a standard internal mixer. After cooling the mixture thus obtained during this first non-productive phase, the crosslinking system is then incorporated, at low temperature, in an external mixer, such as an open mill. The combined mixture is then mixed (productive phase) for a few minutes, for example between 5 and 15 min.

The crosslinking system itself is preferably based on sulphur and on a primary vulcanization accelerator, in particular an accelerator of the sulphenamide type. Added to this vulcanization system, are various known secondary accelerators or vulcanization activators, such as zinc oxide, stearic acid, guanidine derivatives (in particular diphenylguanidine), etc., incorporated during the first non-productive phase and/or during the productive phase. The sulphur content is preferably between 0.5 and 5 phr and the primary accelerator content is preferably between 0.5 and 8 phr.

Use may be made, as (primary or secondary) accelerator, of any compound capable of acting as accelerator of the vulcanization of diene elastomers in the presence of sulphur, in particular accelerators of the thiazole type and also their derivatives, accelerators of the thiuram and zinc dithiocarbamate types. These accelerators are more preferably chosen from the group formed by 2-mercaptobenzothiazyl disulphide (abbreviated to “MBTS”), N-cyclohexyl-2-benzothiazyl sulphenamide (abbreviated to “CBS”), N,N-dicyclohexyl-2-benzothiazyl sulphenamide (“DCBS”), N-tert-butyl-2-benzothiazyl sulphenamide (“TBBS”), N-tert-butyl-2-benzothiazyl sulphenimide (“TBSI”), zinc dibenzyldithiocarbamate (“ZBEC”) and the mixtures of these compounds.

The final composition thus obtained is then calendered, for example in the form of a sheet or a slab, in particular for laboratory characterization, or else is extruded in the form of a rubber profiled element that can be used directly as a underlayer, for example as a “base” of a tread of “cap-base” construction.

The vulcanization (or curing) is carried out, in a known manner, at a temperature generally between 130° C. and 200° C., for a sufficient time that may vary, for example, between 5 and 90 min depending in particular on the curing temperature, on the vulcanization system used and on the vulcanization kinetics of the composition in question.

Preferably, the protective elastomer underlayer has, in the vulcanized state (i.e. after curing) a secant modulus in extension, E10, which is less than 30 MPa, more preferably between 5 and 25 MPa, in particular between 10 and 20 MPa.

### II-3.—Tire of the Invention

The rubber composition described previously is therefore used, in the tire of the invention, as a protective elastomer underlayer placed circumferentially on the inside of the crown of the tire, between, on the one hand, the radially outermost part of its tread, that is to say the portion intended to come into contact with the road when rolling, and, on the other hand, the belt that reinforces said crown.

It should therefore be understood that this protective underlayer is placed:
either under the tread (i.e. radially internally relative to this tread), between the tread and the belt;
or in the tread itself, but in this case under the portion (i.e. radially internally relative to this portion) of tread which is intended to come into contact with the road when the tire is rolling, through the service life of the latter.

It may also be recalled that, in the second case, the tread is commonly referred by a person skilled in the art as a tread of “cap-base” construction; the term “cap” denotes the patterned portion of the tread intended to come into contact with the road and the term “base” denotes the unpatterned portion of the tread, of different formulation, which is not intended to come into contact with the road.

The thickness of this protective elastomer layer is preferably between 0.1 and 2 mm, in particular in a range from 0.2 to 1.5 mm.

The appended FIGS. 1 and 2 very schematically (especially without respect to a specific scale) represent, in radial cross section, two preferred examples of motor vehicle pneumatic tires having radial carcass reinforcement, in accordance with the invention.

FIG. 1 illustrates a first possible embodiment of the invention, according to which the protective elastomer underlayer (3b) is integrated into the tread (3) itself, and placed under the portion (3a) of the tread (3) which is intended to come into contact with the road during rolling.

In this FIG. 1, the pneumatic tire (1) shown schematically comprises a crown (2) surmounted by a tread (3) (for simplicity, comprising a very simple tread pattern), the radially outer part (3a) of which is intended to come into contact with the road, two inextensible beads (4) in which a carcass reinforcement (6) is anchored. The crown (2), joined to said beads (4) by two sidewalls (5), is, in a manner known per se, reinforced by a crown reinforcement or “belt” (7) which is at least partly metallic and radially external with respect to the carcass reinforcement (6), formed for example from at least two superposed crossed plies reinforced by metal cords.

The carcass reinforcement (6) is here anchored into each bead (4) by winding around two bead wires (4a, 4b) the turn-up (6a, 6b) of this reinforcement (6) being for example positioned towards the outside of the tire (1), which is shown here mounted on its rim (9). The carcass reinforcement (6) is formed from at least one ply reinforced by radial textile cords, that is to say these cords are placed practically parallel to one another and extend from one bead to the other so as to form an angle of between 80° and 90° with the median circumferential plane (plane perpendicular to the axis of rotation of the tire which is located half way between the two beads 4 and passes through the middle of the crown reinforcement 7). Of course, this tire (1) additionally comprises, in a known mariner, an inner elastomer or rubber compound layer (commonly referred to as “inner liner”) that defines the radially inner face of the tire and that is intended to protect the carcass ply from the diffusion of air coming from the space inside the tire.

This tire (1) in accordance with the invention is characterized in that the base part (3b) of its tread (3) is formed by the underlayer that has been described in detail above.

FIG. 2 illustrates another possible embodiment of the invention, according to which the protective elastomer underlayer (8) is external to the tread (i.e. different from the latter), this time placed in the crown (2) below the tread (i.e. radially internal relative to the latter) and above the belt (i.e. radially external relative to the latter), in other words between the tread (3) and the belt (7).

In the above two schematically represented cases, the protective elastomer underlayer, owing to its improved water-barrier properties, gives the tires of the invention an effective protection against the unwanted effects of the water which may penetrate through their tread, and diffuse towards their belt, as is demonstrated in the following rubber tests.

### II-4.—Rubber Tests

For the requirements of this test, a rubber composition (denoted hereinbelow by C-1) was prepared, the formulation of which is given in Table 1, the content of the various products being expressed in phr (part by weight per hundred parts of rubber (elastomer), here composed of SBR and NR).

The manufacture of this composition was carried out in the following manner: the reinforcing filler (carbon black), the platy filler (comprising graphite particles), the SBR and the second diene elastomer (natural rubber) and also the various other ingredients, with the exception of the vulcanization system, were successively introduced into an internal mixer, the initial vessel temperature of which was around 60° C.; the mixer was thus filled to around 70% (% by volume). Thermomechanical working (non-productive phase) was then carried out in one stage of around 2 to 4 min, until a maximum “dropping” temperature of 165° C. was reached. The mixture thus obtained was recovered and cooled and then sulphur and an accelerator of sulphenamide type were incorporated into an external mixer (homofinisher) at 30° C., the combined mixture being mixed (productive phase) for a few minutes. The composition thus obtained was then calendered in the form of sheets (thickness equal to 1 mm) that could be used as a base (underlayer) of a tire tread.

This composition C-1 was compared to a standard composition (denoted hereinbelow by C-2, using a blend of BR and NR elastomers) for a underlayer or base of a tread of “cap-base” type. The composition C-2, prepared in the same manner as the composition C-1, differed from the composition C-1 by the use of a polybutadiene elastomer (BR) instead of the SBR elastomer, and by the absence of platy filler.

In order to characterize the water-barrier properties of these two compositions, the following simple test was carried out: a “skim” (layer having a thickness equal to around 2 mm) having a rubber composition referred to as a receiving rubber composition (denoted hereinbelow by C-3), having dimensions of 150 mm by 150 mm, was “sandwiched” between two skims (layers having a thickness equal to around 1 mm) of the “barrier” compositions to be tested (C-1 or C-2) in a mould of suitable dimensions. The final assembly thus moulded formed a block of rubber in the shape of a parallelepiped having dimensions of 150 mm by 150 mm and a total thickness equal to 4 mm. The composition C-3 used was a known rubber composition, conventionally used for calendering metallic tire belt plies based on (peptized) natural rubber and on carbon black N326 (55 phr).

After curing (vulcanisation) of several rubber blocks thus prepared, for 30 min at 150° C. and under a pressure of 15 bar (rectangular piston of 150×150 mm), the latter were removed from the mould in order to be finally subjected to a series of wet heat treatments at 55° C. and under a relative humidity of 95%, for a maximum duration of 2 weeks. After treatment, samples of the receiving compositions C-3 were removed from the centre of the rubber blocks by stripping, their water content (% by weight of receiving composition) was determined by a Karl-Fischer titration and compared to the initial content before treatment (namely around 0.5%, irrespective of the barrier composition tested).

The results given in Table 2 express the water uptake, that is to say the increase in the water content observed in the receiving composition C-3 for the two barrier compositions (C-1 or C-2) tested, in which the receiving composition was moulded. A water uptake of +2.0% expressed, for example, for the barrier composition C-2 after a treatment of 14 days means that the amount of water (% by weight of receiving composition) present in the receiving composition C-3 has changed from 0.5% (initial state) to 2.5% (final state) after treatment.

After wet heat treatment, it is observed that the barrier composition C-1, which can be used as a protective elastomer underlayer in the tire of the invention, has a water-barrier property which is very significantly improved relative to the composition C-2 of the prior art: with this barrier composition C-1, regardless of the treatment time, the increase in the amount of (unwanted) water collected in the composition C-3 after wet heat treatment, is around two times lower in comparison to the conventional composition C-2.

In conclusion, the elastomer underlayer of the radial tire of the invention has excellent water-barrier properties, giving the tire and its belt significantly improved protection against the risks of water penetration through the tread.

TABLE 1

| Formulation: | phr |
|---|---|
| SBR (1) | 80 |
| NR (2) | 20 |
| carbon black (3) | 50 |
| platy filler (4) | 30 |
| ZnO | 3 |
| stearic acid | 1 |
| antioxidant (5) | 2 |
| sulphur | 3 |
| accelerator (6) | 1.5 |

(1) SBR solution comprising 41% of stirene units and 59% of butadiene units; with, for the butadiene part, 24% of 1,2-units, 50% of trans-1,4-units and 26% of cis-1,4-units (Tg = −28° C.);
(2) (peptized) natural rubber;
(3) ASTM grade N550 (Cabot);
(4) graphite particles (Timrex ® 80X150 mesh-Timcal);
(5) N-1,3-dimethylbutyl-N-phenyl-para-phenylenediamine (Santoflex 6-PPD from Flexsys);
(6) N-dicyclohexyl-2-benzothiazolsulphenamide (“Santocure CBS” from Flexsys).

TABLE 2

| Water uptake (% by weight) | Invention | Control |
|---|---|---|
| of the receiving composition (C-3) | (barrier C-1) | (barrier C-2) |
| after treatment of 5 days | +0.55 | +1.15 |
| after treatment of 10 days | +0.90 | +1.70 |
| after treatment of 14 days | +1.10 | +2.00 |

1. A radial tire for a motor vehicle, comprising:
a crown surmounted by a tread provided with at least one radially outer part intended to come into contact with the road;
two inextensible beads, two sidewalls connecting the beads to the tread, a carcass reinforcement passing into the two sidewalls and anchored in the beads;
the crown being reinforced by a crown reinforcement or belt placed circumferentially between the carcass reinforcement and the tread;
a radially inner elastomer layer named “underlayer” underlayer, having a formulation different from the formulation of the radially outer elastomer layer, this underlayer being placed between the radially outer layer of the tread and the belt,
wherein said underlayer comprises 50 to 100 phr of a copolymer based on stirene and on butadiene, a reinforcing filler and between 10 and 150 phr of a platy filler.

2. The tire according to claim 1, wherein said copolymer is chosen from the group consisting of stirene-butadiene copolymers, stirene-butadiene-isoprene copolymers and blends of such copolymers.

3. The tire according to claim 2, wherein said copolymer is a stirene-butadiene copolymer.

4. The tire according to claim 1, wherein said copolymer has a glass transition temperature which is above −40° C.

5. The tire according to claim 4, wherein the glass transition temperature of said copolymer is above −35° C.

6. The tire according to claim 5, wherein the glass transition temperature of said copolymer is between −30° C. and 0° C.

7. The tire according to claim 1, wherein said copolymer based on stirene and on butadiene is used as a blend with a second diene elastomer, different from said copolymer based on stirene and on butadiene.

8. The tire according to claim 7, wherein the second diene elastomer is chosen from the group consisting of natural rubbers, synthetic polyisoprenes, polybutadienes, isoprene copolymers and blends of these elastomers.

9. The tire according to claim 8, wherein the second diene elastomer is an isoprene elastomer.

10. The tire according to claim 9, wherein the isoprene elastomer is natural rubber.

11. The tire according to claim 1, wherein the content of said copolymer in the underlayer is within a range from 50 to 90 phr.

12. The tire according to claim 11, wherein the content of said copolymer in the underlayer is within a range from 60 to 85 phr.

13. The tire according to claim 1, wherein the content of second diene elastomer in the underlayer is within a range from 10 to 50 phr.

14. The tire according to claim 13, wherein the content of second diene elastomer in the underlayer is within a range from 15 to 40 phr.

15. The tire according to claim 1, wherein the content of reinforcing filler in the underlayer is greater than 20 phr.

16. The tire according to claim 15, wherein the content of reinforcing filler is within a range from 30 to 70 phr.

17. The tire according to claim 1, wherein the reinforcing filler comprises silica or carbon black or a mixture of silica and carbon black.

18. The tire according to claim 1, wherein the content of platy filler in the underlayer is between 20 and 100 phr.

19. The tire according to claim 18, wherein the content of platy filler is within a range from 25 to 80 phr.

20. The tire according to claim 1, wherein the platy filler is chosen from the group consisting of graphites, talcs, micas and mixtures of such fillers.

21. The tire according to claim 20, wherein the platy filler comprises graphite particles.

22. The tire according to claim 1, wherein the underlayer additionally comprises a hydrocarbon plasticizing resin.

23. The tire according to claim 1, wherein the underlayer has a thickness between 0.1 and 2 mm.

24. The tire according to claim 23, wherein the underlayer has a thickness within a range from 0.2 to 1.5 mm.

25. The tire according to claim 1, wherein the underlayer constitutes the base of a tread of cap-base construction.

26. The tire according to claim 1, wherein the underlayer is external to the tread, placed between the tread and the belt.

27. (canceled)
